(19) United States
(12) Patent Application Publication
(10) Pub. No.: US 2026/0108879 A1
(43) Pub. Date: Apr. 23, 2026

(54) FLUID FLOW SPLITTING DEVICE FOR MICROFLUIDIC APPLICATIONS

(71) Applicant: Vanderbilt University, Nashville, TN (US)

(72) Inventors: Alexis K. Yates, Nashville, TN (US); Heather N. Murray, Nashville, TN (US); Ethan S. Lippmann, Nashville, TN (US)

(21) Appl. No.: 19/363,198

(22) Filed: Oct. 20, 2025

Related U.S. Application Data
(60) Provisional application No. 63/709,255, filed on Oct. 18, 2024.

(51) Int. Cl. B01L 3/00

(52) U.S. Cl. CPC B01L 3/502715; B01L 2300/0864; B01L 2300/12

(57) ABSTRACT

A microfluidic flow splitting device comprising a substrate, an inlet channel, a plurality of outlet channels, and a junction. The inlet channel is coupleable to a supply tube providing a sample fluid and includes a height that is less than an inner diameter of the supply tube. The plurality of outlet channels are coupleable to and in fluid communication with a downstream microfluidic device. The junction is in fluid communication with the inlet channel and the plurality of outlet channels. The sample fluid is provided to the inlet channel at a volumetric flow rate up to 3 ml/min, and each of the plurality of outlet channels is configured to provide a portion of the sample fluid to a respective downstream microfluidic device at a volumetric flow rate between 0.01 to 3 ml/min.

### CROSS-REFERENCE TO RELATED APPLICATIONS

This application is a non-provisional of and claims the benefit of U.S. Provisional Patent Application No. 63/709,255, filed on Oct. 18, 2024, the contents of which are incorporated herein by reference.

### STATEMENT REGARDING FEDERALLY SPONSORED RESEARCH OR DEVELOPMENT

This invention was made with government support under Grant Numbers AG058524 and NS110665, awarded by the National Institutes of Health, and Grant Number 1846860 awarded by the National Science Foundation. The government has certain rights in the invention.

### BACKGROUND

Microfluidic devices are defined by the application of fluid flow to micron-scale features. Inherent to most experiments involving microfluidic devices is the need to precisely and reproducibly control fluid flow at the microliter scale, often through multiple inlet ports on a single device. While the number of fluid channels per device varies, perfusing multiple inputs requires either the use of multiple flow controllers (e.g., syringe or peristaltic pumps) or the ability to evenly divide fluid across outlets. Towards the latter approach, while a handful of commercial systems exist for splitting fluid flow, these set-ups require significant financial investment, multiple flow control and sensing components, and restrict the user to a predetermined perfusion control system. Simple in-line splitting devices, such as manifolds or T junctions, fail to achieve flow splitting at low flow rates often used in microfluidic systems.

Accordingly, it would be desirable to provide a tool for simplifying microfluidic experiments that require evenly divided flow streams, while minimizing the overall device footprint.

### SUMMARY

The present disclosure provides a tool for academic research labs needing to split low volumetric flow across multiple microfluidic devices, while also being easily implemented into existing flow set ups with minimal footprint.

The present disclosure provides a microfluidic flow splitting device with: (1) a small surface area that allows it to fit on top of a standard microscope slide; (2) connection ports which can be easily modified to fit with a variety of connectors and tubing sizes; (3) consistent <8% coefficient of variation between outlets at Qf=0.01−3 mL/min (averaging about 10% difference between outlet flow rates).

In one embodiment, the present disclosure provides a microfluidic flow splitting device comprising a substrate, a first channel formed in the substrate, the first channel having a first end and a second end, the first end configured to couple to inlet tubing, a junction formed in the substrate at the second end of the first channel, a second channel formed in the substrate, the second channel having a first end and a second end, the first end in fluid communication with the junction, and a third channel formed in the substrate, the second channel having a first end and a second end, the first end in fluid communication with the junction. The first end of the first channel includes a height that is less than an inner diameter of the inlet tubing, and the second channel and the third channel are oriented at an angle of less than 90 degrees relative to an axis of the first channel.

In some aspects, the first channel includes a width at the first end that is greater than a width of the second end of the second channel and a width of the second end of the third channel.

In some aspects, the width at the first end of the first channel is two times greater than the width of the second end of the second channel and the width of the second end of the third channel.

In some aspects, a volumetric flow rate through the device is less than 3 ml/min.

In some aspects, a volumetric flow rate through the device is less than 1 ml/min.

In some aspects, a diameter of the second end of the second channel is equal to a diameter of the second end of the third channel.

In some aspects, the height of the first end of the first channel is between 0.1 mm and 0.5 mm.

In some aspects, the height of the first end of the first channel is 0.3 mm.

In some aspects, the second channel and the third channel are oriented at an angle of 20 to 70 degrees relative to an axis of the first channel.

In some aspects, the second channel and the third channel are oriented at an angle of 30 to 60 degrees relative to an axis of the first channel.

In some aspects, the second channel and the third channel are oriented at an angle of 31 to 32 degrees relative to an axis of the first channel.

In another embodiment, the present disclosure provides a microfluidic flow splitting device comprising a substrate, an inlet channel formed in the substrate, the inlet channel coupleable to a supply tube providing a sample fluid, the inlet channel including a height that is less than an inner diameter of the supply tube, a plurality of outlet channels formed in the substrate, the plurality of outlet channels coupleable to and in fluid communication with a downstream microfluidic device, and a junction formed in the substrate, the junction in fluid communication with the inlet channel and the plurality of outlet channels. The sample fluid is provided to the inlet channel at a volumetric flow rate up to 3 ml/min, and each of the plurality of outlet channels is configured to provide a portion of the sample fluid to a respective downstream microfluidic device at a volumetric flow rate between 0.01 to 3 ml/min.

In some aspects, the substrate comprises polydimethylsiloxane (PDMS).

In some aspects, the plurality of outlet channels are oriented at an angle of less than 90 degrees relative to an axis of the inlet channel.

In some aspects, the plurality of outlet channels are oriented at an angle of 20 to 70 degrees relative to an axis of the inlet channel.

In some aspects, the plurality of outlet channels are oriented at an angle of 30 to 60 degrees relative to an axis of the inlet channel.

In some aspects, the plurality of outlet channels are oriented at an angle of 31 to 32 degrees relative to an axis of the inlet channel.

In some aspects, the inlet channel includes a width at a proximal end that is greater than a width of a distal end of each of the plurality of outlet channels.

In some aspects, the inlet channel at the proximal end is two times greater than the width of the distal end of each of the plurality of outlet channels.

Other aspects of the present disclosure will become apparent by consideration of the detailed description and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A illustrates a microfluidic flow splitting device according to an embodiment of the present disclosure.

FIG. 1B illustrates a fabrication process of a microfluidic flow splitting device according to an embodiment of the present disclosure.

FIG. 1C are pictures of various alternate flow splitting devices that were tested and compared to the microfluidic flow splitting device of FIG. 1B.

FIG. 2 graphically illustrates splitting precision of alternate flow splitting devices, with each point representing the measured volumetric flow rate at various inlet flow rates. Each outlet (two per device) was measured in triplicate (six total measurements) at six inlet flow rates across the range of pump speeds (1-100, arbitrary units). Data are grouped by outlet 1 (circle) or outlet 2 (triangle). All alternate flow splitting devices except the device of FIG. 1B failed to split flow until the inlet flow rate was >2 mL/min and therefore statistical analysis of average difference is not relevant to data interpretation. Red arrows below graphs indicate complete failure to split flow for at least one experimental replicate.

FIG. 3A illustrates a 2D COMSOL model of the inlet junction cross-section of the device of FIG. 1B and T-Splitter. Graphics represent the surface velocity distribution at an inlet velocity of 0.00908 m/s.

FIG. 3B is a graph illustrating average velocity at the outlet junction from a 2D COMSOL model of the microfluidic flow splitting device and an alternate splitting device with inlet velocity of 0.00908 m/s (solid) and 0.0884 m/s (check).

FIG. 4 (A), (B), and (C) are graphs comparing microfluidic flow splitting devices fabricated from the same mold (e.g., V1A mold, devices V1A, V1B, V1C). Each outlet for each device was measured in triplicate (6 total data points) at three pump speeds across the entire pump range (1-100 AU). Data is grouped by outlet 1 (circle) or outlet 2 (triangle). (D) illustrates a 3D representation of V1 of the microfluidic flow splitting device showing profilometer measurement points (Ra=average surface roughness, D1−2=channel diameter measurements).

FIG. 5A illustrates surface roughness of 3D printed molds along inlet channel surface (500 μm).

FIG. 5B illustrates profilometer measurements of channel diameter across replicate 3D printed molds from the same V1 CAD design, each data point corresponds to the measured width of one outlet. One measurement was taken across each outlet channel near the termination point.

FIG. 6A illustrates 2D surface velocity plot of COMSOL model replicating outlet diameter differences of V1A and V1C molds as measured by profilometer (reducing diameter of indicated outlet by 9% and 3.2%, respectively). Splitter bifurcation is shown, green arrows indicate outlet with reduced diameter.

FIG. 6B graphically illustrates a comparison of the average outlet velocity calculated from COMSOL simulation of V1A and V1C splitting devices at multiple inlet flow rates. Significance determined by unpaired t-test.

FIG. 7A illustrates various versions of the microfluidic flow splitting device to test impact of various geometry features on flow splitting precision. For each additional design, one feature from the original V1 splitter was changed as noted on in FIGS. 7B-D.

FIGS. 7B-D graphically illustrate splitting precision of the various versions shown in FIG. 7A, with each point representing the measured volumetric flow rate at various inlet flow rates. Each outlet was measured in triplicate (6 total data points) at six pump speeds across the entire pump range (1-100 AU). Data is grouped by outlet 1 (circle) or outlet 2 (triangle). Red arrows indicated a complete failure to split flow (water exiting only 1 outlet).

FIG. 8A illustrates various pumps used for testing the microfluidic flow splitting devices.

FIG. 8B illustrates V1 splitter precision was compared between a peristaltic and syringe pump. Splitting precision was not significantly altered by the pump source, although the syringe pump dampened the outlet flow rate at pump speeds >1 mL/min. Nested 1-way ANOVA multiple comparisons testing was used to compare the peristaltic versus syringe pump outlet flow rates at the corresponding inlet flow rate.

### DETAILED DESCRIPTION

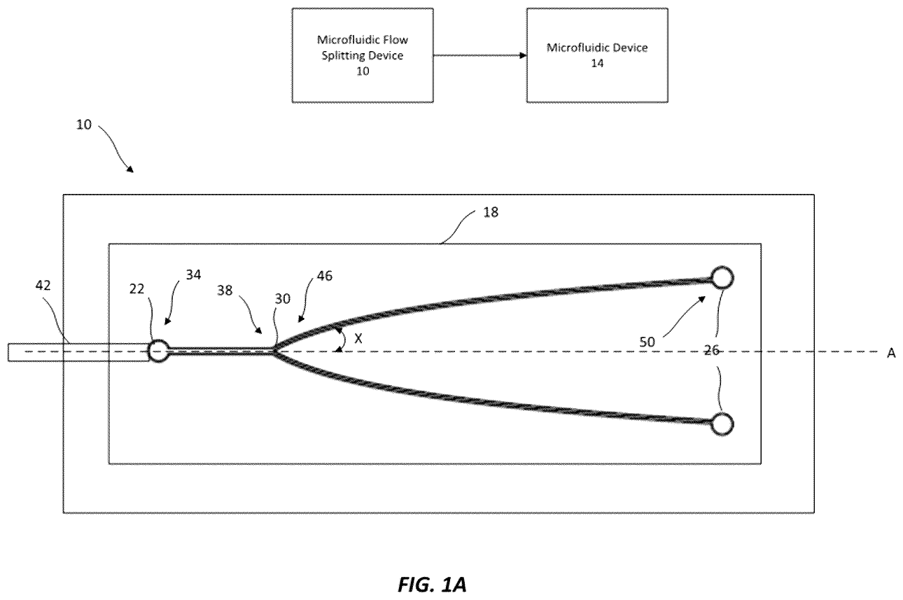

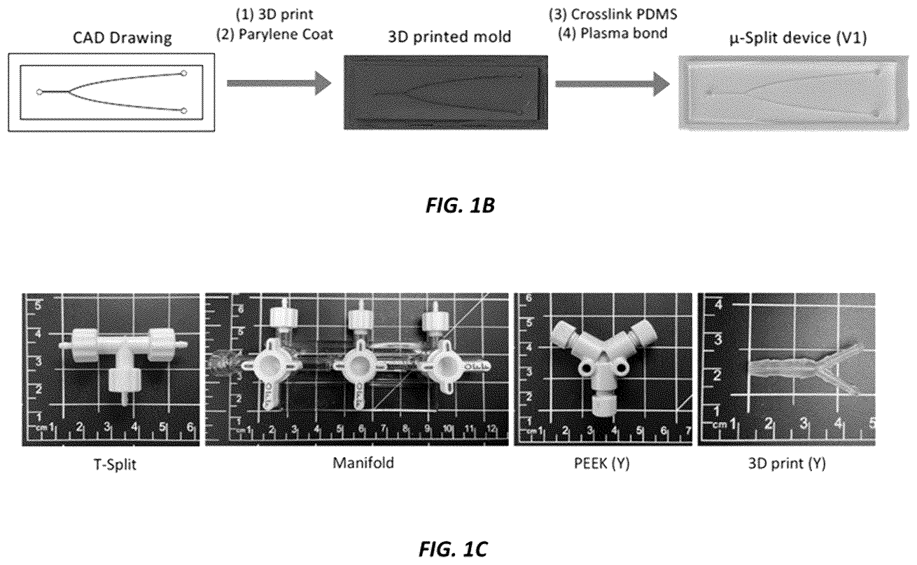

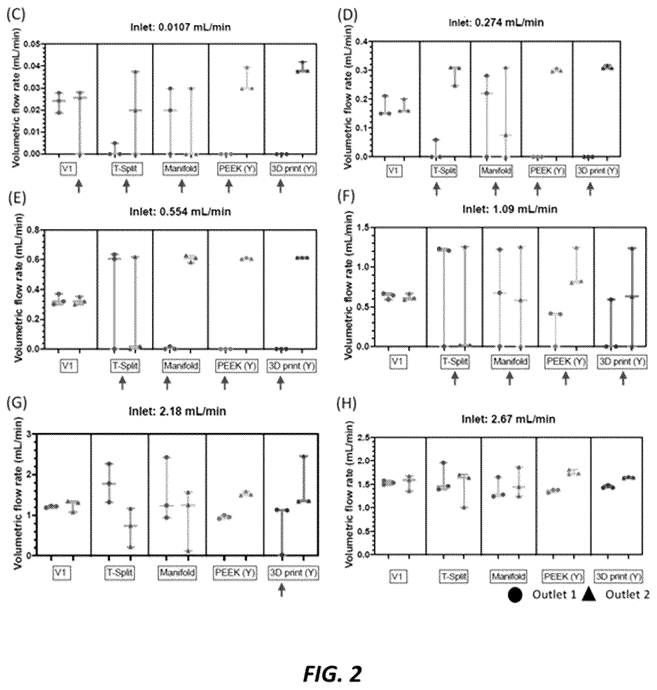

FIG. 1A illustrates a microfluidic flow splitting device 10 according to an embodiment of the present disclosure. The microfluidic flow splitting device 10 is positioned upstream of one or more microfluidic devices 14 and is in fluid communication with the one or more microfluidic devices 14. The microfluidic flow splitting device 10 provides a plurality of evenly divided sample fluid streams to the microfluidic devices 14.

The microfluidic flow splitting device 10 includes a substrate 18, an inlet channel 22, a plurality of outlet channels 26, and a junction 30. The inlet channel 22, the plurality of outlet channels 26, and the junction 30 are formed within the substrate. In some embodiments, the substrate 18 comprises polydimethylsiloxane (PDMS). In some embodiments, the substrate 18 has a small surface area that allows it to fit on top of a standard microscope slide (e.g., about 75 mm by 25 mm). An example method of fabricating the microfluidic flow splitting device 10 is described below.

The inlet channel 22 includes a first (proximal) end 34 and a second (distal) end 38. The first end 34 is coupleable to a supply tube 42, which provides a sample fluid for experimental or testing purposes. The second end 38 is in fluid communication with the junction 30. The plurality of outlet channels 26 include a first (proximal) end 46 and a second (distal) end 50. The plurality of outlet channels 26 extend from the junction 30 and are in fluid communication with the junction 30 and the inlet channel 22. The second end 50 of the outlet channels 26 are in fluid communication with an inlet of the one or more microfluidic devices 14. As illustrated, only two outlet channels 26 are shown however it is within the scope of the disclosure that more than two outlet channels are possible. The inlet channel 22 includes an axis A. The plurality of outlet channels 26 are oriented at an angle X relative to the axis A. In some configurations, the angle X is less than 90 degrees. In other configurations, the angle X is between 20 to 70 degrees. In still other configurations, the angle X is between 30 to 60 degrees. In yet another configuration, the angle X is between 31 to 32 degrees.

The inlet channel 22 includes a height H, a width W, and a length L, and the outlet channels 26 include a height H2, a width W2, and a length L2. In some configurations, the height H is less than an inner diameter of the supply tube 42. In some configurations, the width W is two times greater than the width W2 of the outlet channels. In one example, the height H is 0.3 mm and the inner diameter of the supply tube 42 is 0.8 mm. In this example, the length L is 10 mm and the width W is 0.6 mm. In this same example, the length L2 is 43 mm and the width W2 is 0.3 mm. Also, in this same example, the angle X is 31.5 degrees.

In one embodiment, these dimensions are suitable for splitting low volumetric flow of a sample fluid across multiple microfluidic devices 14. For example, the sample fluid is provided to the inlet channel 22 at a volumetric flow rate up to 3 ml/min, and each of the outlet channels 26 is configured to provide a portion of the sample fluid to a respective downstream microfluidic device 14 at a volumetric flow rate between 0.01 to 3 ml/min with less than an 8% coefficient of variation between the outlet channels 26.

### EXAMPLE

Microfluidic flow splitting devices 10 were fabricated using a cleanroom-free approach. High-resolution SLA 3D printing was utilized for mold fabrication to achieve feature sizes of 50 μm, which allowed for rapid prototyping of macro- to microfluidic devices that can be moved from initial ideation to completed device in about three days. The CAD designs for device 10 variations were drawn in Autodesk Fusion360 (version 2.0) and prepared for 3D printing with PreForm software (available from Formlabs, version 3.34). Molds were printed with an SLA 3D printer (e.g., Black v4 resin, Form 3, Formlabs) and coated with parylene C dimer (e.g., Labcoater 3 PDS 2010, available from Specialty Coating Systems) to facilitate PDMS crosslinking and inhibit cytotoxicity for downstream applications. To make the devices, a 9:1 ratio of PDMS (e.g., polydimethylsiloxane, SYLGARD 184) to curing agent were mixed thoroughly, cast onto molds, and degassed in a vacuum chamber for 30-60 minutes. A 9:1 ratio of elastomer to curing agent resulted in the appropriate flexibility of the cured polymer to allow for fluid-tight connections. Following degassing, devices were cured overnight at 55° C. After curing, PDMS was demolded, inlet/outlet holes were punched with a 1.5 mm biopsy punch, and the devices were irreversibly bonded to prepared microscope slides by O₂-plasma surface activation. Inlet and outlet holes were connected to perfusion tubing via bent stainless steel connectors (e.g., PN-BEN-16G, available from Darwin Microfluidics).

The device variations were tested with platinum-cured silicon tubing (e.g., ID=0.8 mm, MFLX96410-13, VWR) with 90 mm length connected to each outlet and connected to 2-stop peristaltic pump tubing (e.g., MFLX95723-36, VWR) via barbed luer connectors. A peristaltic pump (available from Ismatec) was used to perfuse the devices unless otherwise noted. Ultrapure water was used as the perfusion fluid for the measurements. A syringe pump (available from Harvard Apparatus, Pico Plus Elite) was used with the same tubing setup to test device compatibility with alternate pump systems.

Measurements of the volumetric flow rate (Qf) were collected using two methods: 1) a liquid flow sensor (e.g., SLF3f-0600, available from Sensirion) directly attached to each of the splitter outlets in turn with an equal length tubing attached to the outlet that did not have the sensor (measurements averaged over the duration of the testing period, lasting approximately 1-2 minutes); 2) manual measurements of bulk flow by recording the mass of water exiting each outlet over time and assuming a constant liquid density of 1 g/mL. Outlet tubing was maintained at the same height to ensure there was not a significant pressure difference between outlets during flow rate measurements. The perfusion tubing, splitters, and outlet tubing were fully primed with water to ensure no inconsistencies would be introduced by bubble entrapment before beginning volumetric flow rate measurements. To calculate the average fluid velocity (Vf) from the measured Qf (for 2D COMSOL simulations), Qf was divided by the cross-sectional area of the perfusion tubing (ID=0.8 mm) used for all flow rate testing.

For an incompressible fluid moving through a pipe, Bernoulli's equation (eq. 1) states that an increase in velocity will result in a decrease in pressure such that the sum of the static and dynamic pressures to remain constant. According to the conservation of mass, as a fluid moves through a constriction point, the reduction in surface area will result in an increase in fluid velocity. The Venturi effect (eq. 2) is derived from Bernoulli's equation of continuity and can be used for a continuous flow profile to determine the increase in fluid velocity within a constriction point by measuring the pressure drop before (P₁) and during (P₂) a constriction point. In the 2D COMSOL simulations of different splitter inlet points, both sides of the Venturi effect were observed, as discussed below.

$$\frac{{v}^{2}}{2} + gz + \frac{{P}_{1}}{ρ} = fluid constant \qquad ( eq . 1 )$$

$$\frac{ρ}{2} ( {v}_{1}^{2} - {v}_{2}^{2} ) = {P}_{2} - {P}_{1} \qquad ( eq . 2 )$$

Equation 1 is a general form of Bernoulli's equation, which states that for an incompressible fluid of constant density (ρ) the sum of fluid velocity (v), pressure (P), and gravitational potential (g) at height (z) are equal to a constant such that an increase in velocity must result in a decrease in pressure. This is further described by the Venturi effect (eq. 2) which shows that for continuous flow, velocity (v₂) increases at a constriction point (reduced cross-sectional area), pressure (P₂) will decrease compared to pressure upstream of the constriction point (P₁).

The average surface roughness (Ra) and channel diameter of the 3D printed molds was measured with a stylus profilometer (e.g., Bruker Dektak 150). Surface roughness measurements were collected from the midline of the inlet channel. Each measurement was 500 μm long (moving from the inlet towards the channel bifurcation) with a stylus force of 6.5 mg and resolution of 0.014 μm. Three measurements were completed per sample. Measurements of channel width were taken at each outlet, with one diameter measurement per channel (3 total for each device). Differences between outlet channel width within the same mold were compared to the splitting precision between 3D printed mold replicates.

To examine the fluid physics governing the velocity and pressure profiles throughout the device, a 2D model of the splitter geometry was designed using COMSOL Multiphysics software (version 6.2), which utilizes the finite element method (FEM) to provide analytical solutions that approximate the partial differential equations which define the physical forces (i.e. velocity) acting on the object. Geometry of the T-split tubing-to-inlet interface was built from direct caliper measurements of the T-split geometry and known inner diameter of tubing (0.8 mm). For the 2D model of the device tubing-to-inlet interface, the channel height (rather than width) was chosen to represent the inlet because it is the smallest-sized feature (0.3 mm vs 0.6 mm). The device geometry was drawn directly from CAD design file dimensions and replicated in COMSOL. Modifications to the device outlet diameter were completed by reducing the diameter of the right-side outlet channel, corresponding to profilometer measurements on different devices. All simulations were completed under conditions of steady-state incompressible flow and the simulation fluid was assumed to have the same properties as water at 37° C. No-slip boundary conditions were applied to all walls. Fully developed laminar flow varying from 0.00908-0.0884 m/s (corresponding to measured Qf from the flow loop setup) was set as the average inlet velocity and zero pressure was set at the outlet. Velocity and pressure profiles were solved directly with the PARDISO solver. Comparisons between outlet velocity and pressure were determined by averaging the solution along the length of the outlet boundary.

All data analyses and calculations of statistical significance were performed in GraphPad Prism (version 10.3.1).

The initial device 10 was designed with consideration for a small device footprint and high fluid resistance (FIG. 1B). The design was motivated by an hypothesis that at the low Qf needed for perfusion experiments, the correspondingly low internal velocity may contribute to poor fluid splitting. To overcome this issue, the device 10 was designed with an inlet channel height (0.3 mm) that is smaller than the inlet diameter of the perfusion tubing (0.8 mm), restricting the fluid flow directly at the device inlet before the bifurcation. This restriction of the channel diameter resulted in a temporary increase in volumetric flow and reduction in fluid pressure, described by the Venturi effect, which can be determined from Bernoulli's continuity equation assuming an incompressible fluid with constant total pressure. While the Venturi effect is used for determining volumetric flow rate at a constriction point by measuring differences in pressure, the contribution of channel constriction to fluid velocity is an important feature of the device. It is believed that the effective splitting in the in the device may be due, in part, to this temporary increase in fluid velocity that immediately precedes the fluid bifurcation. All other splitting devices, as described below, have internal diameters that are larger than the inlet tubing, resulting in a reduction in volumetric flow as fluid is entering the splitter.

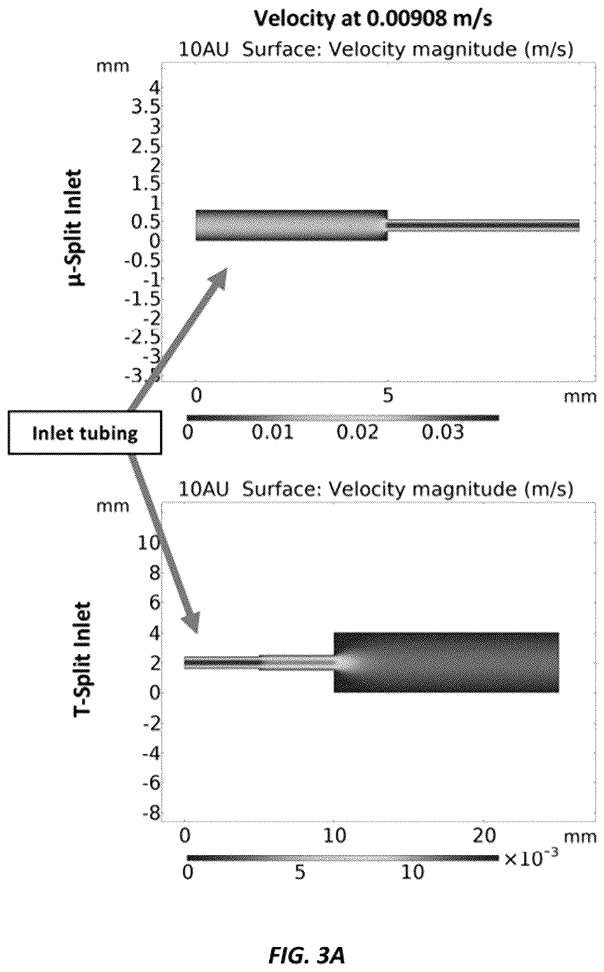

Four different fluid splitting devices (3 purchased, 1 fabricated in-house; FIG. 1C) were tested to compare splitting precision with the present device. A summary of these results is shown in FIG. 2. In order to compare the splitting precision between different splitters, triplicate measurements were taken for each device at each tested inlet flow rate, resulting in six total measurements per device (three per outlet). Across all tested flow rates, the device 10 performed significantly better than the alternate splitting devices under identical perfusion setups. At inlet flow rates <2 mL/min (FIG. 2 (at C-F), all alternate splitters failed to split flow (with water exiting only one outlet), as indicated by the red arrows in the figure. Note that one measurement of the device 10 at 0.0107 mL/min failed to split flow, indicating that further optimization of device design/fabrication could be needed to regularly operate at this low flow rate. At the highest inlet flow rate tested (2.67 mL/min), minimal differences in splitter precision were measure, indicating that splitter design was less critical at higher volumetric flow rates. It was important to note that splitter testing was completed using a setup that is similar to what is regularly utilized for bioreactor perfusion experiments (not shown). When measuring splitter precision, short lengths of tubing (90 mm) were attached to each outlet of the device. If the length of the outlet tubing is substantially increased (e.g., to 300 mm), fluid resistance and the overall splitting precision are also subsequently increased (data not shown). However, with perfusion setups where small footprint, simplicity, and mobility are crucial to improving experimental success (for example, in applications involving cells where devices are transferred in and out of incubators), a splitting device that requires long outlet tubing lengths is an impractical addition. The device 10 is designed such that it does not require tubing additions to increase fluid resistance but is self-contained, performing extremely well when inserted directly in-line with existing perfusion components.

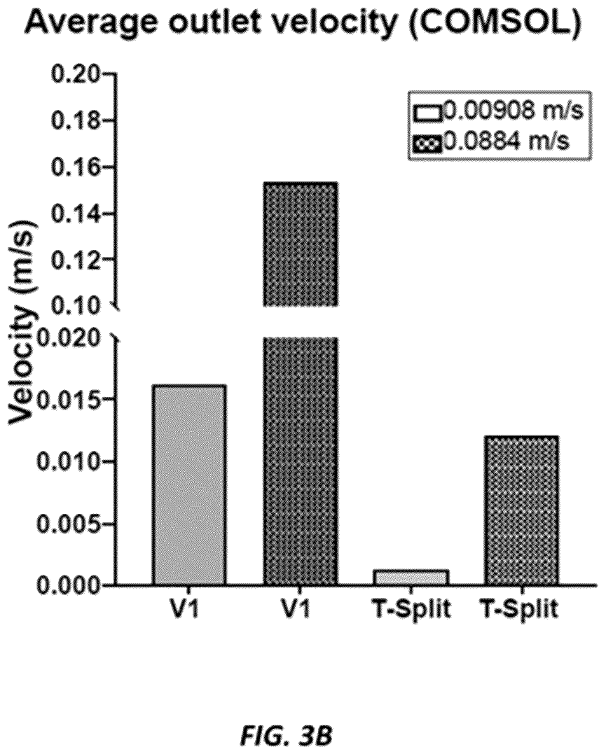

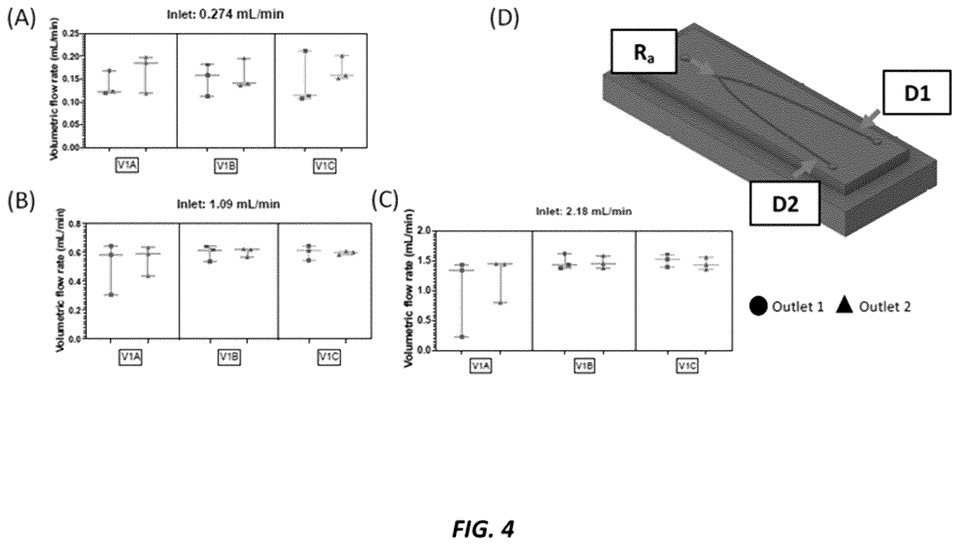

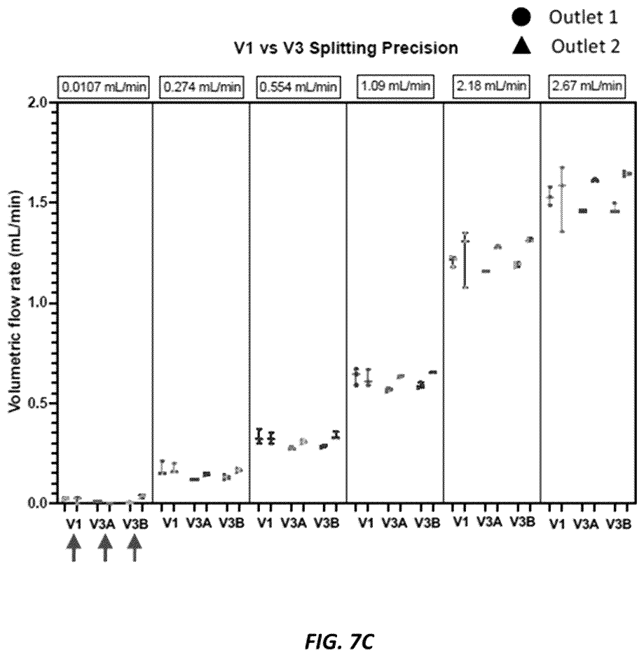

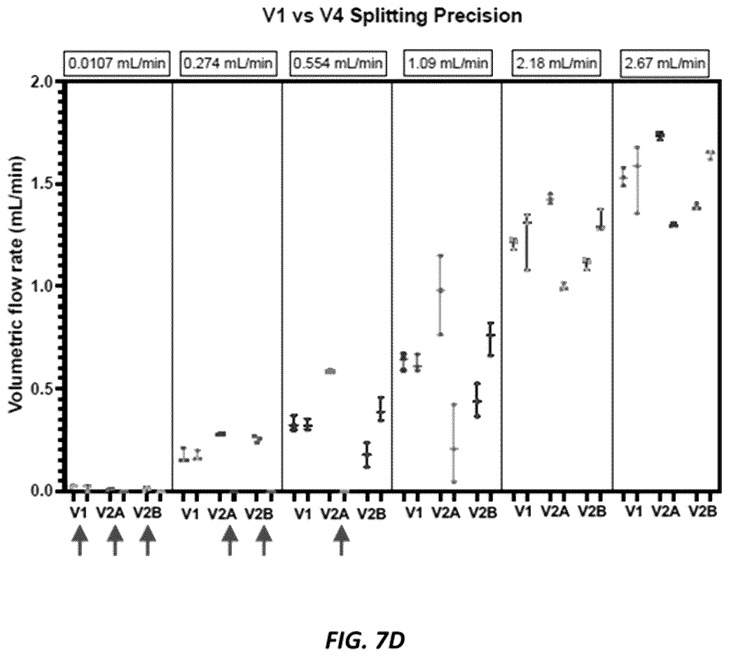

A common feature of the tested alternate splitters was an inlet junction that opened to an internal diameter much greater than the inner diameter of the tubing. The velocity drop at the inlet junction due to the Venturi effect may drive the fluid preferentially towards the outlet with lower hydraulic resistance (dependent on the consistency of device connections and fabrication method). By contrast, increasing the channel constriction at the device inlet for the device 10 results in increased fluid velocity directly before the splitter bifurcation, which is believed may be contributing to the splitting precision. To examine the velocity profile inside the device 10 compared to the T-Split, a 2D COMSOL model was built to simulate the tubing-splitter junction for both splitters (FIG. 3A). At the two inlet velocities tested (0.00908 m/s and 0.0884 m/s, corresponding to 0.274 mL/min and 2.669 mL/min respectively), a dramatic difference was observed in the solutions for the average velocity between the two models, where the average velocity profiles at the outlet boundary were much greater for the device 10 than the T-split (FIG. 3B). This behavior is visually apparent in the velocity surface plots (FIG. 3A), where the fluid velocity following the junction of the tubing and splitter inlet is much higher for the device 10 compared to the T-split. The T-split, manifold, and 3D printed Y-splitter all have an inner diameter much greater than the perfusion tubing, which results in a reduction in fluid velocity as water enters the larger inlet. Further salient features were tested by designing and fabricating a new device (V4) with inner channel dimensions greater than the inlet tubing diameter, thus reducing the channel constriction of the device while keeping all other features (split angle, channel length) identical. As can be seen in FIG. 7D, the V4 device failed to split flow at less than 1 mL/min and performed poorly compared to the V1 device. Hence, in situations relevant to perfusion of microfluidic devices, the device 10 achieves more even flow splitting, likely due to the constriction at the splitter inlet which results in a local increase in velocity at the splitter bifurcation due to the Venturi effect.

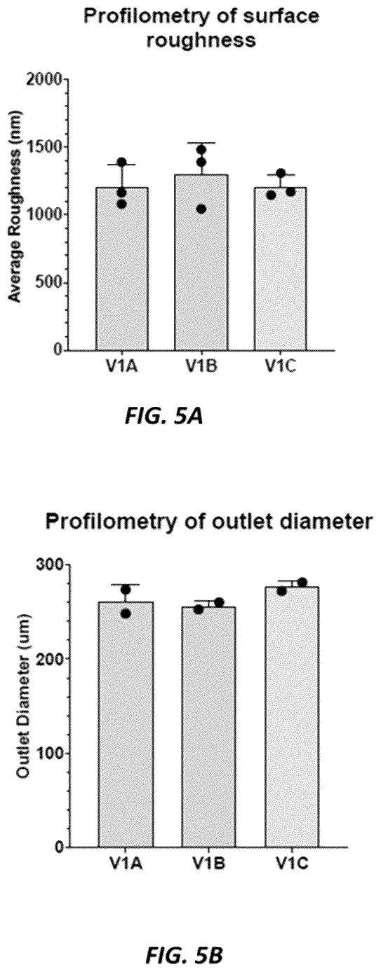

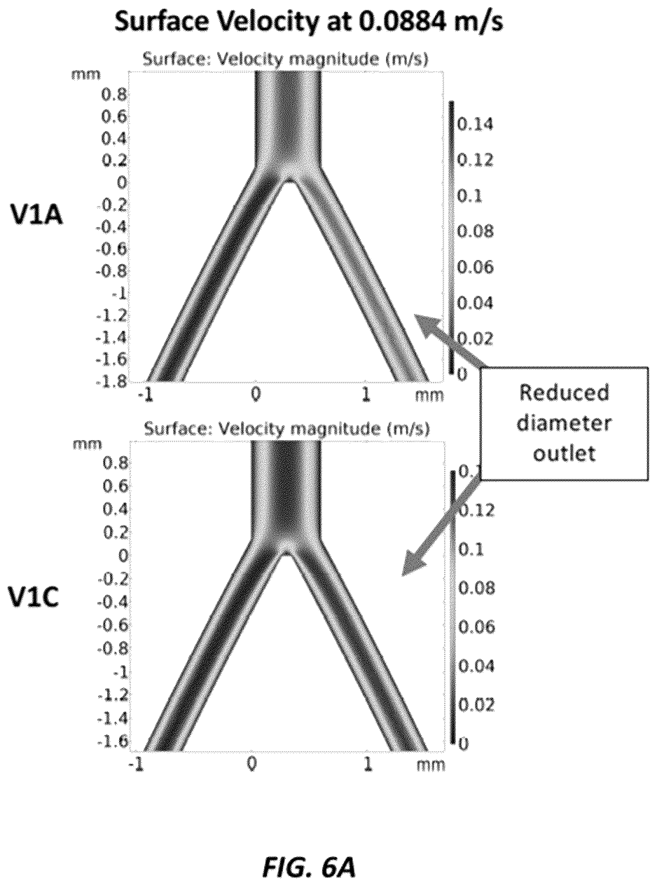

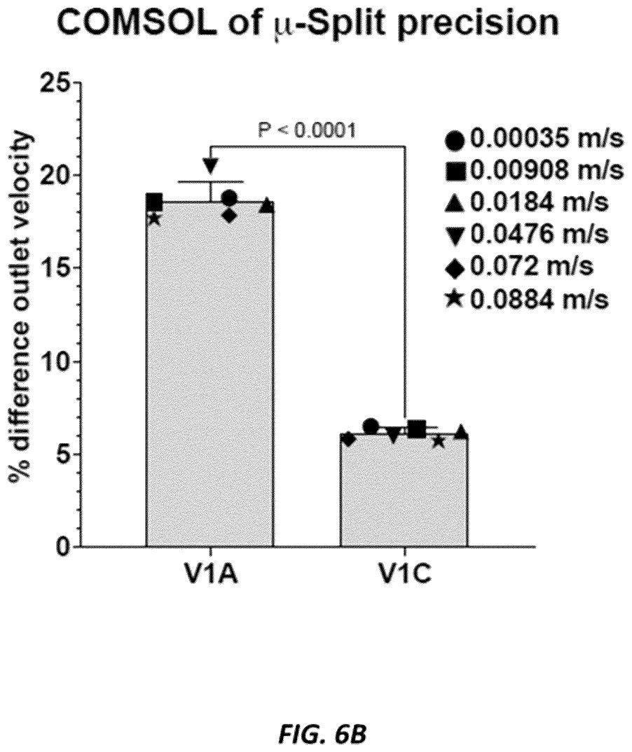

While testing the splitting precision of the geometry of the device 10, it was observed that replicate molds from the same design had variable splitting precision (FIG. 4), with one mold (V1A) consistently underperforming the other two replicates (V1B, V1C), despite all molds being printed from the same CAD file. After further fabrication and testing of device replicates from the same molds (e.g., V1A 1-3), it was concluded that the differences were introduced by the features of the mold itself rather than the fabrication process, as there were no discernible differences in splitting precision on replicate devices from the same parent mold. From previous experience with 3D printing, it was hypothesized that either the surface or feature imperfections in the original 3D printed master mold were responsible for discrepancies between devices produced from each mold. To test this possibility, a stylus profilometer was used to quantify the surface roughness and the channel diameter for each 3D printed mold (see FIG. 4 (at D) for measurement locations). These measurements demonstrated no significant difference in surface roughness across all three replicate molds (FIG. 5A), but the poorest performing device (V1A) had a slightly higher difference between outlet diameters compared to the other molds (FIG. 5B). The hydraulic resistance between the two outlet channels was also calculated, according to the profilometer measurements of outlet channel width (FIG. 5B). Hydraulic resistance of a rectangular channel was calculated with Equation 3 where R_{H} represents hydraulic resistance, L is the channel length, h is the height, w is the width, and μ is the viscosity of water (0.001 Pa-s). In order for the calculations of R_{H} to be positive, w>>h, therefore the width and height values were exchanged with the outlet channels. Table 1 shows the R_{H} for each outlet of V1A and V1C based on the average width from profilometry measurements and using a length of 42 mm.

$${R}_{H} = \frac{12 μ L}{{wh}^{3} ( 1 - 0.63 \frac{h}{w} )} \qquad Eq . 3$$

TABLE 1
Hydraulic resistance R_{H} of V1 splitter outlet channels

| | | | Average | | |
|---|---|---|---|---|---|
| Splitter | | | width | R_{H} | % difference R_{H} |
| Version | Outlet | Height | (um) | (Pa-s/m³) | between outlets |
| V1A | 1 | 536.6 | 273.76 | 6.75 × 10¹⁰ | 24.9% |
| | 2 | 536.6 | 248.1 | 8.68 × 10¹⁰ | |
| V1C | 1 | 548.1 | 281.2 | 6.11 × 10¹⁰ | 8.3% |
| | 2 | 548.1 | 272.1 | 6.64 × 10¹⁰ | |

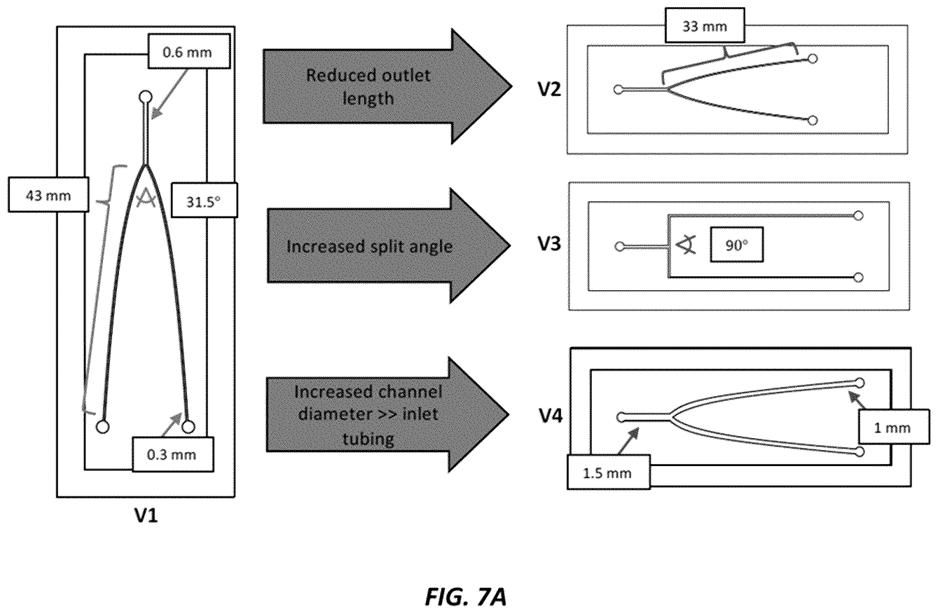

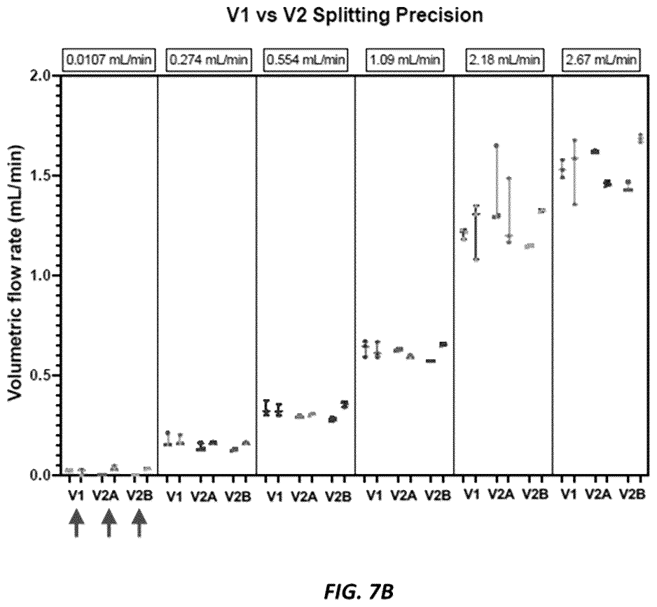

To further examine the impact of different outlet channel widths on splitting precision, 2D COMSOL models of best- and worst-performing splitters were built by adjusting the outlet diameters to differ by the same percentages measured by the profilometer (FIG. 6A). Comparing the average outlet boundary velocity for the two models shows a significantly better splitting precision for the device with higher symmetry outlet channel diameters (FIG. 6B). The percent difference in simulated fluid velocity between the two outlets of V1A (˜20%) is very similar to the difference in theoretical R_{H} (24.9%) shown in Table 1. The V1C splitter showed the same relationship between R_{H} (8.3% different between outlets) and simulated flow rates (˜6% different between outlets). These outcomes support the hypothesis that improving device precision by higher resolution fabrication methods (such as photolithography or CNC milling) would further reduce the variability in flow splitting between the outlet channels of the device, especially at low flow rates.

The central problem observed is that under low volumetric flow, precision flow splitting can only be achieved with adequate channel constriction imparted at the microfluidic splitter (rather than further downstream in the fluidic loop). By introducing a high constriction point at the bifurcation junction, superior control over fluid splitting relative to all tested commercially available alternates was achieved. To better understand more nuanced considerations for flow splitting, the consequences of modifying outlet length, split angle, and channel constriction was tested, all while remaining within the original design parameters (FIG. 7A). As expected from previous testing of the increase in inlet velocity of the device compared to commercial splitter, it was observed that reduced fluid constriction due to larger inlet channels resulted in consistently worse splitter performance (where performance specifically relates to the ability of the splitter to split fluid flow at the tested flow rate), with the V4 splitter completely failing to split flow less than 1 mL/min (see V1 vs V4; FIG. 7D). From previous experience with fluid splitting, it is believed that the outlet length might have an important role in effective fluid splitting. However, reducing the outlet length (FIG. 7B) did not significantly reduce splitting precision, except at the lowest inlet flow rate (0.0107 mL/min) where precision of the V1 splitter is also low. A similar outcome was seen when the split angle was increased to 90° while holding all other features constant (FIG. 7C), which did not significantly impact fluid splitting. Overall, it was determined that channel constriction is the most important feature governing even flow splitting, which agrees with outcomes in FIGS. 3A and 3B. The initial device design (V1) continues to be the best performing under the perfusion conditions that were tested-namely, the conditions relevant to biological device applications.

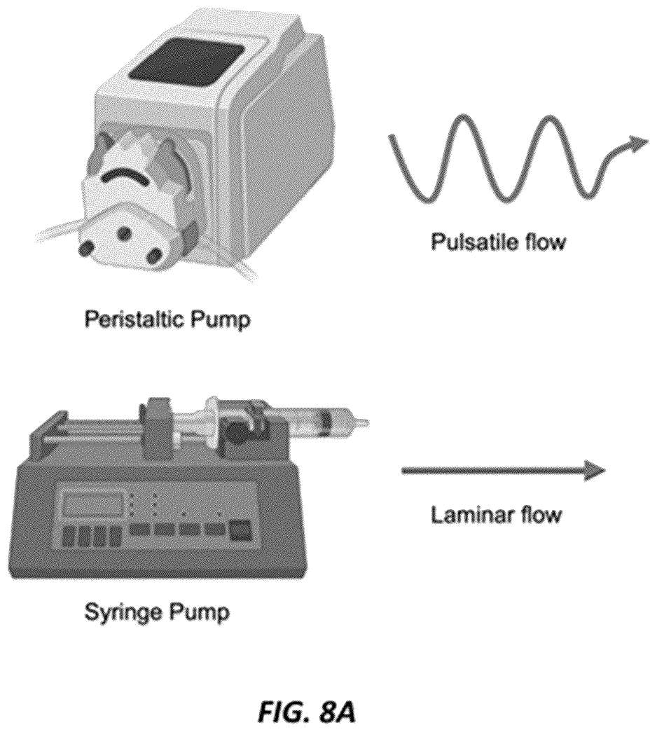

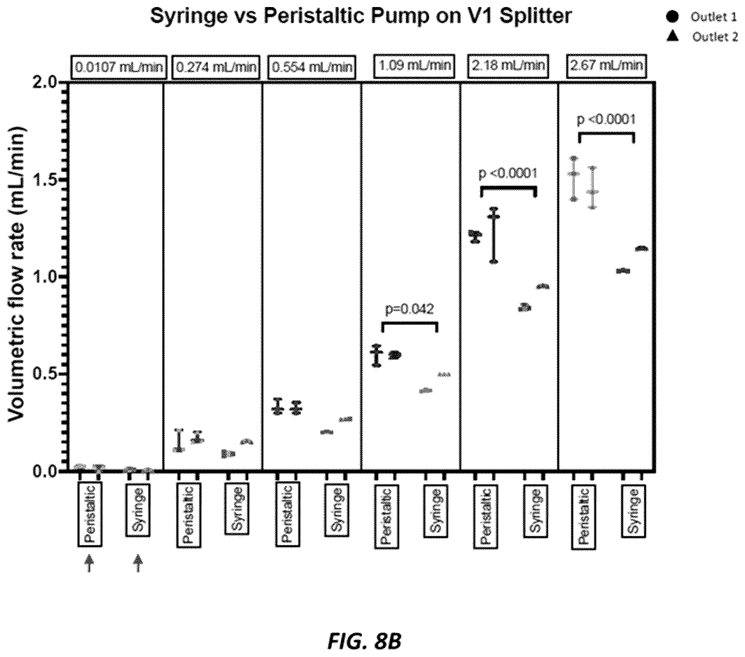

The performance of the V1 device was compared by using two different pump systems: a peristaltic pump and a syringe pump (FIG. 8A). By testing the device under identical inlet flow rates and using the same perfusion tubing, it was confirmed that the different fluid flow profile due to the pump mechanics did not impact the splitting efficiency between both pumps (FIG. 8B). However, a modest decrease in the overall outlet flow rate was observed with the syringe pump, which was especially obvious at inlet flow rates greater than 1 mL/min. Thus, the flow profile does not impact splitting capabilities but can result in differential flow dampening.

In this specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

Various features and advantages of the embodiments and examples presented herein are set forth in the following claims.

What is claimed is:

1. A microfluidic flow splitting device comprising:
a substrate;
a first channel formed in the substrate, the first channel having a first end and a second end, the first end configured to couple to inlet tubing;
a junction formed in the substrate at the second end of the first channel;
a second channel formed in the substrate, the second channel having a first end and a second end, the first end in fluid communication with the junction; and
a third channel formed in the substrate, the second channel having a first end and a second end, the first end in fluid communication with the junction;
wherein the first end of the first channel includes a height that is less than an inner diameter of the inlet tubing, and
wherein the second channel and the third channel are oriented at an angle of less than 90 degrees relative to an axis of the first channel.

2. The microfluidic flow splitting device of claim 1, wherein the first channel includes a width at the first end that is greater than a width of the second end of the second channel and a width of the second end of the third channel.

3. The microfluidic flow splitting device of claim 2, wherein the width at the first end of the first channel is two times greater than the width of the second end of the second channel and the width of the second end of the third channel.

4. The microfluidic flow splitting device of claim 1, wherein a volumetric flow rate through the device is less than 3 ml/min.

5. The microfluidic flow splitting device of claim 1, wherein a volumetric flow rate through the device is less than 1 ml/min.

6. The microfluidic flow splitting device of claim 1, wherein a diameter of the second end of the second channel is equal to a diameter of the second end of the third channel.

7. The microfluidic flow splitting device of claim 1, wherein the height of the first end of the first channel is between 0.1 mm and 0.5 mm.

8. The microfluidic flow splitting device of claim 7, wherein the height of the first end of the first channel is 0.3 mm.

9. The microfluidic flow splitting device of claim 1, wherein the second channel and the third channel are oriented at an angle of 20 to 70 degrees relative to an axis of the first channel.

10. The microfluidic flow splitting device of claim 9, wherein the second channel and the third channel are oriented at an angle of 30 to 60 degrees relative to an axis of the first channel.

11. The microfluidic flow splitting device of claim 10, wherein the second channel and the third channel are oriented at an angle of 31 to 32 degrees relative to an axis of the first channel.

12. A microfluidic flow splitting device comprising:
a substrate;
an inlet channel formed in the substrate, the inlet channel coupleable to a supply tube providing a sample fluid, the inlet channel including a height that is less than an inner diameter of the supply tube;
a plurality of outlet channels formed in the substrate, the plurality of outlet channels coupleable to and in fluid communication with a downstream microfluidic device; and
a junction formed in the substrate, the junction in fluid communication with the inlet channel and the plurality of outlet channels;
wherein the sample fluid is provided to the inlet channel at a volumetric flow rate up to 3 ml/min, and
wherein each of the plurality of outlet channels is configured to provide a portion of the sample fluid to a respective downstream microfluidic device at a volumetric flow rate between 0.01 to 3 ml/min with less than an 8% coefficient of variation between the outlet channels.

13. The microfluidic flow splitting device of claim 12, wherein the substrate comprises polydimethylsiloxane (PDMS).

14. The microfluidic flow splitting device of claim 12, wherein the plurality of outlet channels are oriented at an angle of less than 90 degrees relative to an axis of the inlet channel.

15. The microfluidic flow splitting device of claim 14, wherein the plurality of outlet channels are oriented at an angle of 20 to 70 degrees relative to an axis of the inlet channel.

16. The microfluidic flow splitting device of claim 15, wherein the plurality of outlet channels are oriented at an angle of 30 to 60 degrees relative to an axis of the inlet channel.

17. The microfluidic flow splitting device of claim 16, wherein the plurality of outlet channels are oriented at an angle of 31 to 32 degrees relative to an axis of the inlet channel.

18. The microfluidic flow splitting device of claim 12, wherein the inlet channel includes a width at a proximal end that is greater than a width of a distal end of each of the plurality of outlet channels.

19. The microfluidic flow splitting device of claim 18, wherein the inlet channel at the proximal end is two times greater than the width of the distal end of each of the plurality of outlet channels.
